(19) United States
(12) Patent Application Publication
(10) Pub. No.: US 2009/0129092 A1
(43) Pub. Date: May 21, 2009

(54) HEAT CONVECTION DISSIPATER FOR LED LAMP

(76) Inventor: Shyh-Ming Chen, Taipei County (TW)

Correspondence Address: Shyh-Ming Chen, 235 Chung - Ho Box 8-24, Taipei, 235, TW

(21) Appl. No.: 11/943,590

(22) Filed: Nov. 21, 2007

(51) Int. Cl. F21V 29/02

(52) U.S. Cl. 362/294

(57) ABSTRACT

A heat convection dissipater for an LED lamp, comprises a convection heat dissipating device for an LED lamp, a light emitting diode module having a plurality of light emitting diodes; a heat dissipating unit behind the light emitting diode module for dissipating heat from the light emitting diode module set; a housing having a plurality of air holes at a lateral side thereof; the housing being engaged to the heat dissipating unit so as to form an internal space; and a blade wheel combined to the housing. Heat from the light emitting diodes is transferred to the internal space through the heat dissipating unit; external air is guided into the internal space through the air holes so as to drive air originally in the internal space flows toward the blade wheel to push the blade wheel to rotate so as to circulate the air in the internal space.

### FIELD OF THE INVENTION

The present invention is related to heat dissipaters, and particularly to a heat convection dissipater for an LED lamp, wherein heat convention channel is formed naturally so that heat emitted from the light emitting diodes can exhaust out from a housing.

### BACKGROUND OF THE INVENTION

Light emitting diodes have the advantages of lower power consumption, long lifetime, short response time, compact size, etc. Furthermore, the technology of the light emitting diodes is improved, which can emit light of different wavelengths so as to match the tiny elements or array elements. Currently, light emitting diodes will replace some lighting devices used in electric devices, electronic devices and communication devices, such as indication lights, displays, vehicle outside lights, back light sources from LCD, handsets, etc.

Currently, the working principle of a light emitting diode (LED) is that a voltage is applied to electrodes of a semiconductor material so as to stimulate light from the material. Generally, high power LED has a problem of heat dissipation. In one prior art, conducting pines of an LED are added with heat dissipating elements so as to dissipate heat from the LED. The elements have the effect of enlarging the heat dissipating area. In another prior art, a high power LED is connected to a bottom of a heat dissipater so as to transfer heat from the LED to a plate heat tube or an embedded heat tube embedded into a metal so that heat from the LED will distribute to other area by heat convection. In another prior art, heat conductor and heat dissipating fins are added to the LED lamps for heat dissipation.

In all above mentioned prior art, heat is dissipated by heat transfer and heat exchange. The heat dissipating quantity is

Q=−KA (t2−t1), where, K is a heat transfer coefficient; A is area, t2-t1 are temperature difference, ΔT. Despite the way used for heat dissipating, the temperature at the second end will increase for a long time. Then the temperature difference ΔT between the first and second end becomes smaller. This is because above said heat dissipating ways can not provide a good efficiency. In the mainframe of a computer, a fan can be used to descend the temperature of the second end so that the temperature gradient ΔT (t2−t1) become larger so as to increase heat dissipating efficiency. However it is possible that the LED light is installed outdoors (such as a load light or a vehicle light) so that the fan will destroy as it is used for a long time. Furthermore, the charge free maintenance of the LED light has a finite period. Thus the user must update the element by themselves.

### SUMMARY OF THE INVENTION

The main object of the present invention is to provide a heat convection dissipater for an LED lamp, wherein heat convention channel is formed naturally so that heat emitted from the light emitting diodes can exhaust out from a housing.

The second object of the present invention is to provide a heat convection dissipater for an LED lamp, wherein the heat is transferred mainly by heat convection so that the temperature of the second end can be retained to a lower value; the temperature difference ΔT between the first and second ends are retained.

Moreover, the present invention can increase the heat dissipating effect of an LED lamp which can be applied to a vehicle, as an outdoor lamp and has a longer lifetime.

To achieve above object, the present invention provides a heat convection dissipater for an LED lamp which comprises a light emitting diode module having a plurality of light emitting diodes; a heat dissipating unit behind the light emitting diode module for dissipating heat from the light emitting diode module set; a housing having a plurality of air holes at a lateral side thereof; the housing being engaged to the heat dissipating unit so as to form an internal space; and a blade wheel combined to the housing. Heat from the light emitting diodes is transferred to the internal space through the heat dissipating unit; external air is guided into the internal space through the air holes so as to drive air originally in the internal space flows toward the blade wheel to push the blade wheel to rotate so as to circulate the air in the internal space.

The present invention further comprises an optical mask which is coupled to the housing so as to define an internal space; and the optical mask is installed before the light emitting diode.

The housing has a plurality of through holes for assisting air convection. The heat dissipating unit includes a heat tube, a plurality of heat dissipating fins and a seat. The light emitting diodes of the light emitting diode module are embedded into the seat. The air holes are formed at a lateral side of the housing and the blade wheel is also installed at the lateral side of the housing. The housing has a cambered shape or a tapered shape. A width of the housing is greater than that of the optical mask; and the air holes are installed the same level as the light emitting diode module.

The various objects and advantages of the present invention will be more readily understood from the following detailed description when read in conjunction with the appended drawing.

### BRIEF DESCRIPTION OF THE DRAWINGS

FIG. 1 is an exploded view of the first embodiment of the present invention.

FIG. 2 is an assembled cross sectional view of the first embodiment of the present invention.

FIG. 3 is a schematic view showing the guiding of air according to the first embodiment of the present invention.

FIG. 4 is a schematic view showing the guiding of air according to the second embodiment of the present invention.

FIG. 5 is a schematic view showing the guiding of air according to the third embodiment of the present invention.

FIG. 6 is a schematic view showing the guiding of air according to the fourth embodiment of the present invention.

FIG. 7 is a schematic view showing the guiding of air according to the fifth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

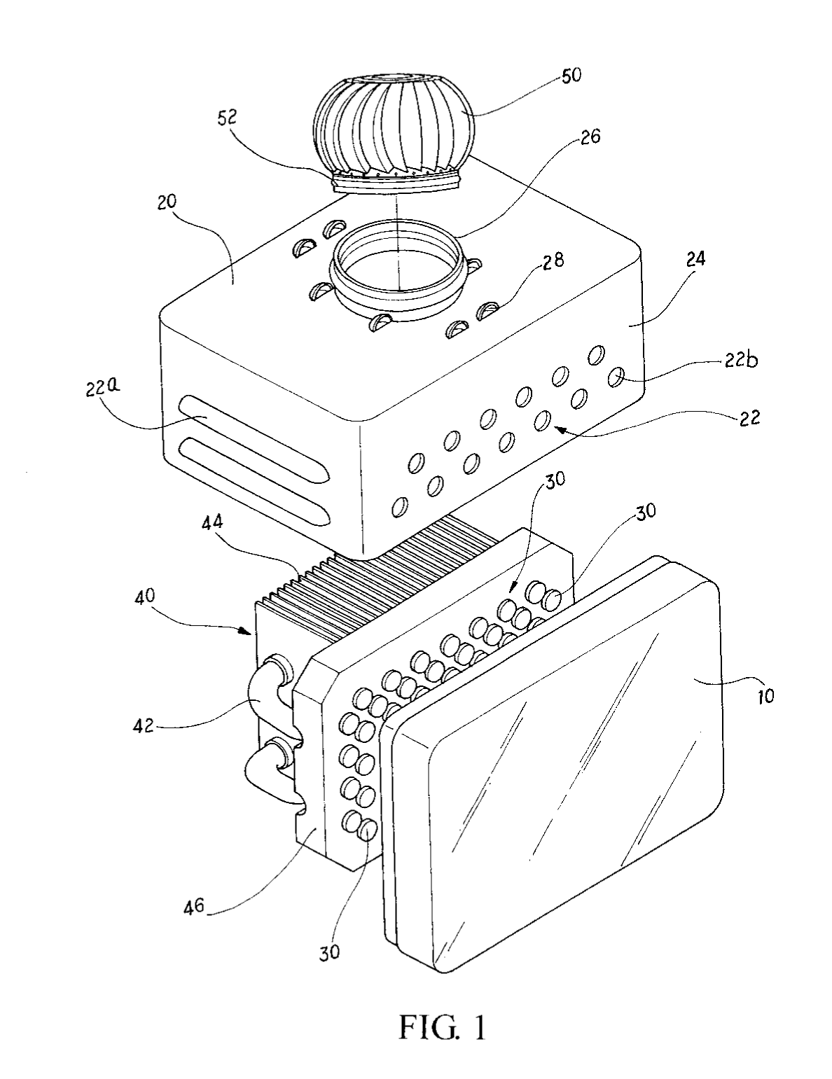

Referring to FIG. 1, the lamp of the present invention has an optical mask 10 which may be made by transparent material, such as plastics or glass, etc.

A light emitting diode module 30 is included in the present invention.

A housing 20 is included.

An optical mask 10 is coupled to the housing 20 so as to form an internal space. The optical mask 10 is installed before a light emitting diode module 30 for transmitting light from the light emitting diode module 30 uniformly.

A heat dissipating unit 40 serves to dissipate heat from the light emitting diode module 30. The heat dissipating unit 40 is installed behind the light emitting diode module 30.

In this embodiment, the heat dissipating unit 40 includes a heat tube 42, a plurality of heat dissipating sheets 44, and a seat 46. However these are not used to confine the scope of the present invention. The heat dissipating sheets 44 can be made with extruding aluminum.

There are many ways for forming the light emitting diode module 30. In this the present invention, the light emitting diodes 30a are directly embedded into the seat 46 of the heat dissipating unit 40. However the light emitting diode 30a can be installed to a base plate. The base plate is combined with the seat 46 of the heat dissipating unit 40.

One surface of the housing 20 is installed with air holes 22 and a blade wheel 50. In this embodiment, the air holes 22 are formed at a front side or the lateral side 24, as shown in drawings. The air hole 22 may have an oblong shape 22a or an elliptical shape 22b. One end of the blade wheel 50 has a connecting end 52 which is combined with a connecting portion 26 of the housing 20. A periphery of housing 20 is formed with a plurality of through holes 28 around the blade wheel 50 for heat dissipation so as to have a good heat dissipating effect.

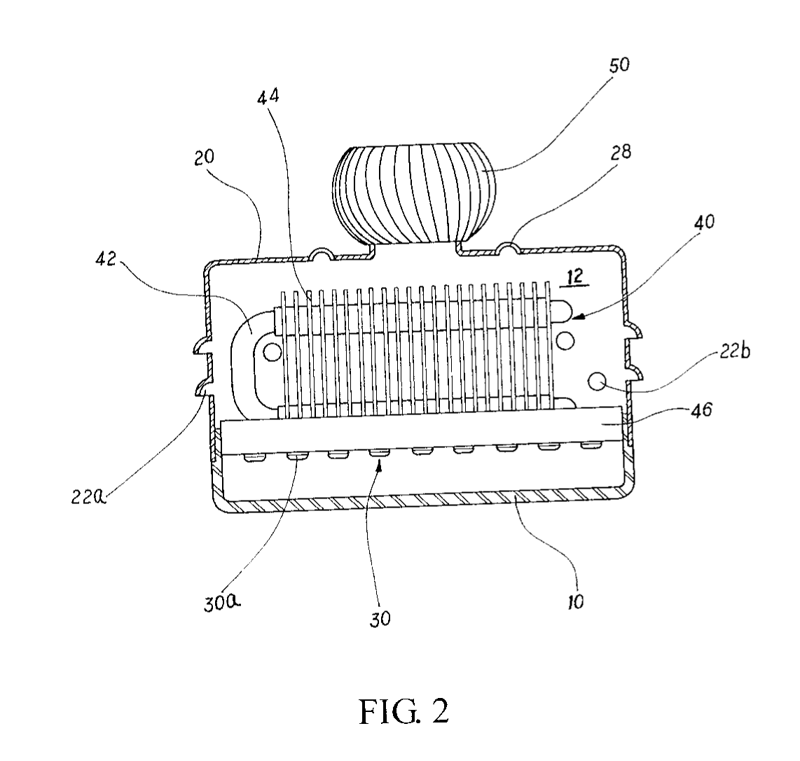

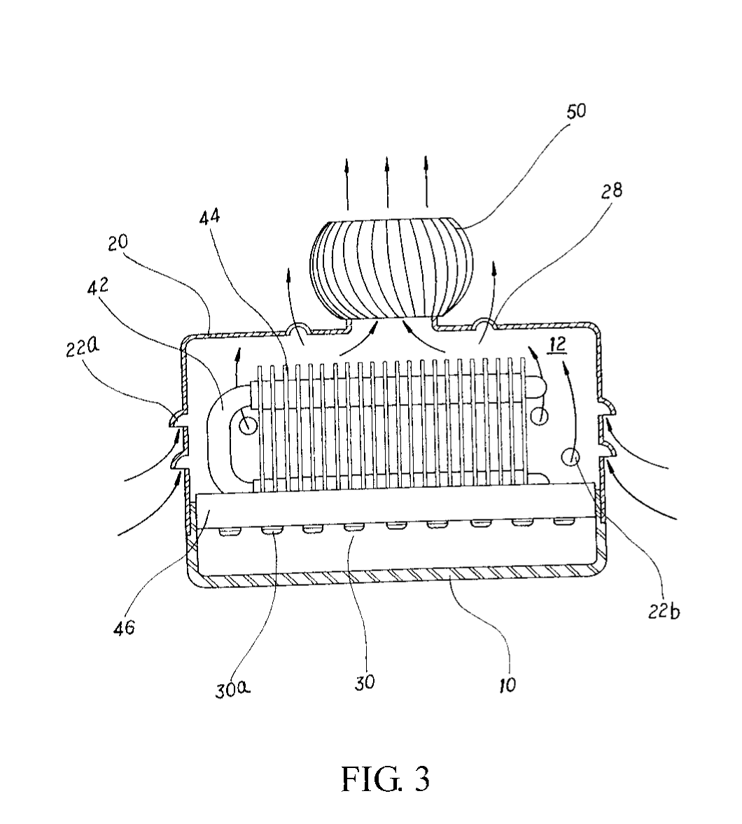

Referring to FIGS. 2 and 3, the present invention is mainly used at head lights of a vehicle, indoor lights, outdoor load lights, etc. The use of light emitting diodes will save a large amount energy. In assembly, the light emitting diode module 30 will emit light to the optical mask 10. After voltage is applied to the light emitting diode 30a, the heat energy generated will transfer to the heat tube 42 and the heat dissipating sheets 44. Then the heat transfers to the inner space 12 in the housing 20. Due to the temperature difference, outside cool air will transfer into the inner space 12 through the air holes 22. The heat in the inner space 12 will flow to another end so as to transfer the heat energy from the heat tube 42 and the heat dissipating sheets 44 and the blade wheel 50 will be pushed to rotate. Thus air flows cyclically. Thus the heat dissipating effect of the present invention is increased.

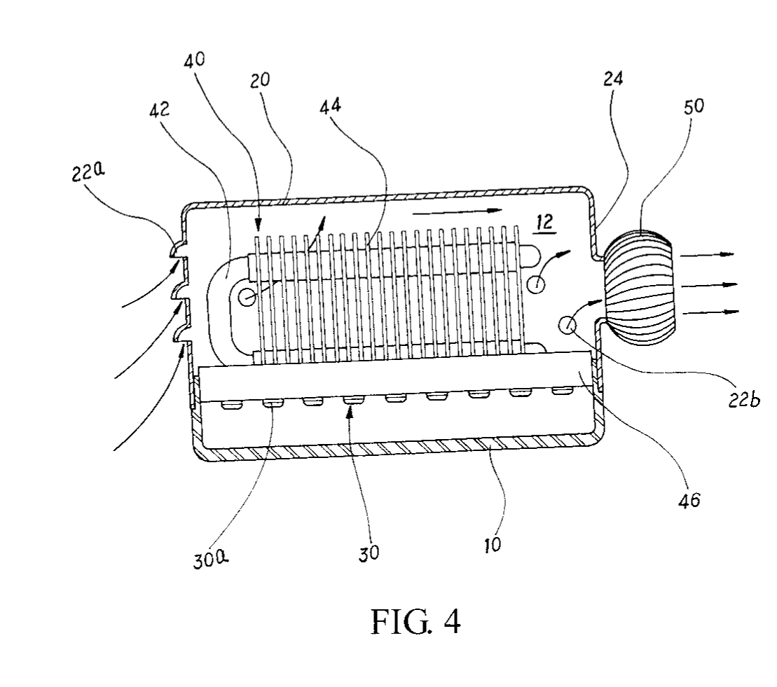

Referring to FIG. 4, the second embodiment of the present invention is illustrated. For conforming various assembly environment, a flat deign is used in the present invention. In that, the air holes 22a, 22b are formed at the lateral side 24 of the housing 20. The blade wheel 50 is installed at the lateral side 24. The air holes 22 will guide cool air into the internal space 12 so as to cool the heat tube 42 and the heat dissipating sheets 44. Furthermore, the blade wheel 50 is driven to rotate. Thus air flows cyclically. In this embodiment, the height can be reduced by draining air laterally.

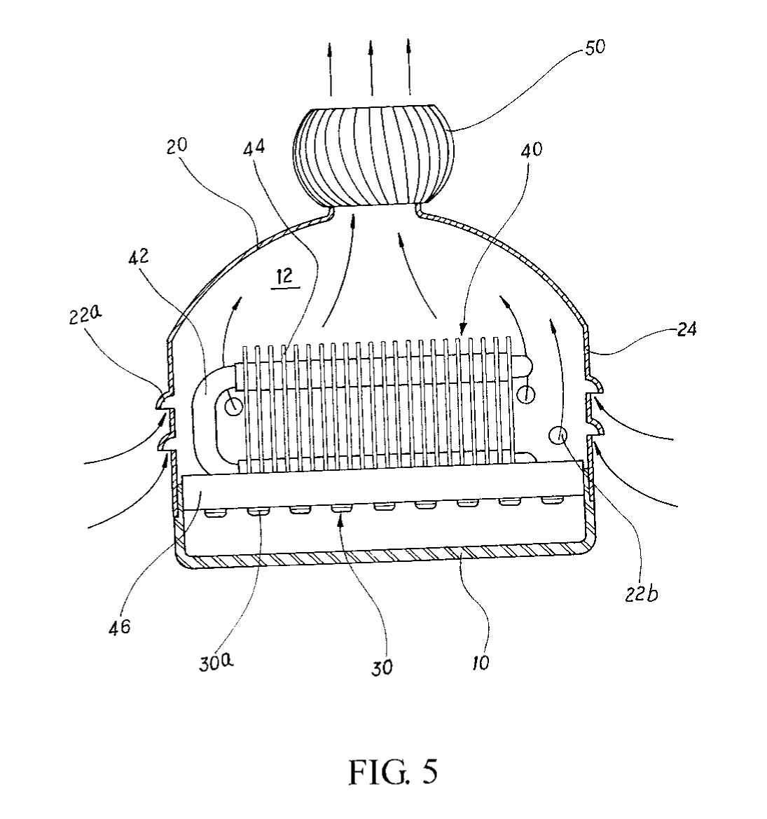

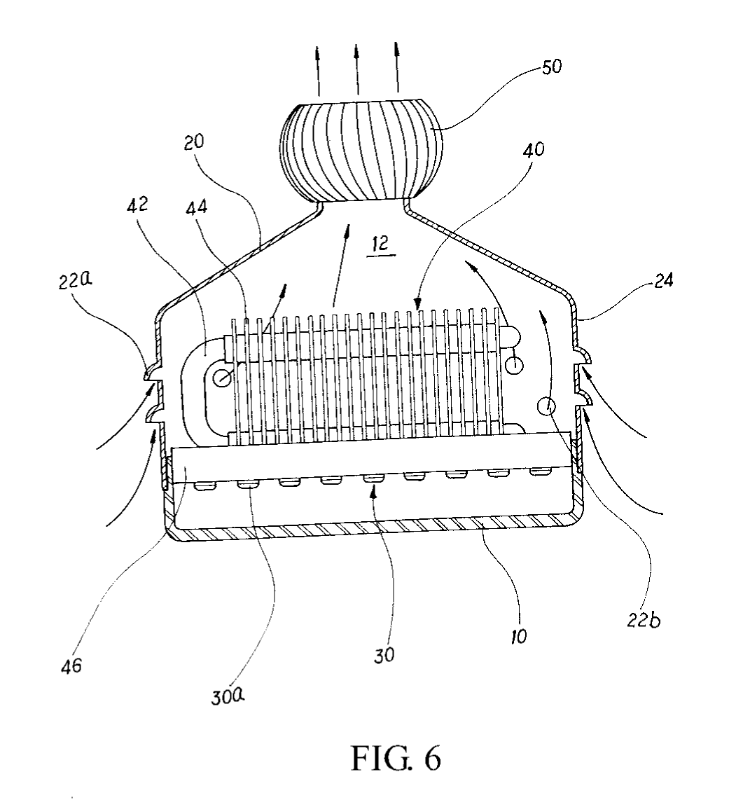

Referring to FIGS. 5 and 6, the third and fourth embodiment of the present invention is illustrated. In this embodiment, those identical to the above embodiment will not be further described herein. Only those different from above embodiment are described. The difference of the present invention from the first embodiment is that the shape of the housing 20. See FIG. 5, an upper side of the housing 20 about the lateral side 24 is formed as a convex cambered shape so as to collect air effectively. The air into the air holes 22a, 22b will transfer heat from the housing 20 so as to drive the blade wheel 50 to rotate. In FIG. 6, an upper side of the housing 20 about the lateral side 24 is formed as a tapered shape so as to collect air effectively.

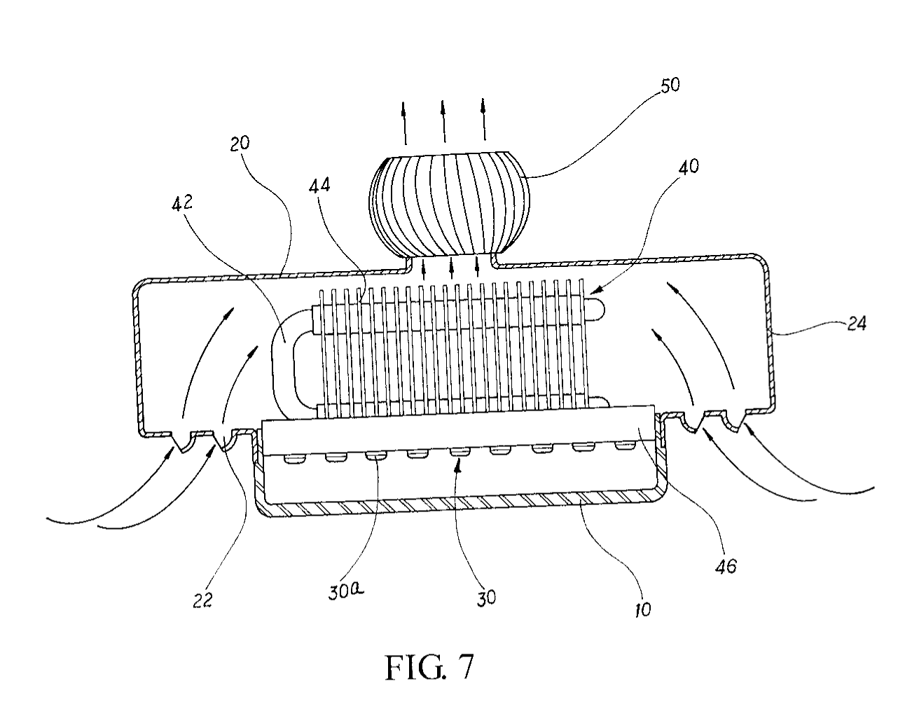

Referring to FIG. 7, the fifth embodiment of the present invention is illustrated. In this embodiment, those identical to the above embodiment will not be further described herein. Only those different from above embodiment are described. In this embodiment, a width of the housing 20 is greater than that of the optical mask 10. Level of the air holes 22 is approximately equal to that of the light emitting diode module 30. The external cool air will flow into the housing 20 so as to cool the heat tube 42 and the heat dissipating sheets 44 and to drive the blade wheel 50 to rotate. Air flows cyclically. However in this embodiment, the air holes 22 can be installed around the periphery of the optical mask 10.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A heat convection dissipater for an LED lamp, comprising;
a convection heat dissipating device for an LED lamp;
a light emitting diode module having a plurality of light emitting diodes;
a heat dissipating unit behind the light emitting diode module for dissipating heat from the light emitting diode module set;
a housing having a plurality of air holes at a lateral side thereof; the housing being engaged to the heat dissipating unit so as to form an internal space; and
a blade wheel combined to the housing; and
wherein heat from the light emitting diodes is transferred to the internal space through the heat dissipating unit; external air is guided into the internal space through the air holes so as to drive air originally in the internal space flows toward the blade wheel to push the blade wheel to rotate so as to circulate the air in the internal space.

2. The heat convection dissipater for an LED lamp as claimed in claim 1, further comprising an optical mask which is coupled to the housing so as to define an internal space; and the optical mask is installed before the light emitting diode module.

3. The heat convection dissipater for an LED lamp as claimed in claim 2, wherein the housing has a plurality of through holes for assisting air convection.

4. The heat convection dissipater for an LED lamp as claimed in claim 1, wherein the heat dissipating unit includes a heat tube, a plurality of heat dissipating fins and a seat.

5. The heat convection dissipater for an LED lamp as claimed in claim 4, wherein the light emitting diodes of the light emitting diode module are embedded into the seat.

6. The heat convection dissipater for an LED lamp as claimed in claim 1, wherein the air holes are formed at a lateral side of the housing and the blade wheel is also installed at the lateral side of the housing.

7. The heat convection dissipater for an LED lamp as claimed in claim 1, wherein the housing has a cambered shape.

8. The heat convection dissipater for an LED lamp as claimed in claim 1, wherein the housing has a tapered shape.

9. The heat convection dissipater for an LED lamp as claimed in claim 1, wherein a width of the housing is greater than that of the optical mask; and the air holes are installed at the same level as the light emitting diode module.
